(19) United States
(12) Patent Application Publication
(10) Pub. No.: US 2023/0403690 A1
(43) Pub. Date: Dec. 14, 2023

(54) ACCESS POINT (AP) INTERFERENCE REDUCTION

(71) Applicant: MAXLINEAR, INC., Carlsbad, CA (US)

(72) Inventors: Saju Palayur, Poway, CA (US); Salvador Iranzo Molinero, Bétera (ES); Anand Krishnasamy Anandakumar, San Diego, CA (US)

(73) Assignee: MAXLINEAR, INC., Carlsbad, CA (US)

(21) Appl. No.: 18/333,442

(22) Filed: Jun. 12, 2023

Related U.S. Application Data
(60) Provisional application No. 63/366,236, filed on Jun. 10, 2022.

(51) Int. Cl. H04W 72/0453

(52) U.S. Cl. CPC H04W 72/0453; H04W 88/08

(57) ABSTRACT

According to an aspect of an example, an access point (AP) may comprise a transceiver configured to receive, at the AP from a backhaul modem, a downlink signal including a signaling aid and a backhaul frame. The AP may comprise a processing device configured to: identify, at the AP, a signaling aid in the downlink signal to detect a downlink backhaul frequency channel; and determine, based on the signaling aid, one or more operating frequencies for the AP, wherein the operating frequencies do not include the backhaul frequency channel.

### RELATED APPLICATION

This application claims the benefit of U.S. Provisional Application No. 63/366,236, filed Jun. 10, 2022, the disclosure of which is incorporated herein by reference in its entirety.

The examples discussed in the present disclosure are related to access point (AP) interference reduction, and in particular, to AP inference reduction to backhaul devices and related receivers.

### BACKGROUND

Unless otherwise indicated herein, the materials described herein are not prior art to the claims in the present application and are not admitted to be prior art by inclusion in this section.

Wi-Fi® communications may be configured to occur in multiple frequency bands, including the 2.4 GHz, 5 GHz, and 6 GHz frequency bands. Additionally, some Wi-Fi® communications may be broadcast over different radio links that may include varying operational frequencies. Some incumbent communication systems may also be configured to communicate using the same or similar frequencies as Wi-Fi® communications. In some circumstances, interference between the Wi-Fi® communications and the incumbent communications may occur.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In one example, a backhaul modem may comprise a processing device and a transceiver. The processing device may be configured to compute, at the backhaul modem, a signaling aid configured for detection by an access point (AP). The processing device may be configured to encode, at the backhaul modem, the signaling aid in combination with a backhaul frame. The processing device may be configured to send, from the backhaul modem for transmission to the AP, a downlink signal including the signaling aid and the backhaul frame to a transceiver. The transceiver may be configured to transmit the downlink signal including the PPDU to the AP.

In another example, an AP may comprise a processing device and a transceiver. The processing device may be configured to detect, at the AP, a backhaul transmission received from a backhaul modem. The processing device may be configured to identify, at the AP, one or more backhaul frequency channels present in the backhaul transmission. The processing device may be configured to compute, at the AP, one or more complementary backhaul frequency channels based on the one or more backhaul frequency channels. The processing device may be configured to compute, at the AP, one or more operating frequency channels, wherein the one or more operating frequency channels do not include: the one or more backhaul frequency channels and the one or more complementary backhaul frequency channels. The transceiver may be configured to transmit, from the AP to a wireless device, a signal using the one or more operating frequency channels.

In another example, an AP may comprise a transceiver configured to receive, at the AP from a backhaul modem, a downlink signal including a signaling aid and the backhaul frame. The AP may comprise a processing device configured to: identify, at the AP, a signaling aid in combination with the backhaul frame to detect a downlink backhaul frequency channel; and determine, based on the signaling aid, one or more operating frequencies for the AP, wherein the operating frequencies do not include the backhaul frequency channel.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example diagram showing service paths in an example service area.

FIG. 2 illustrates a graph showing the transmit power class and device type as a function of frequency in megahertz (MHz).

FIG. 3 illustrates an example of 6 gigahertz (GHz) channels.

FIG. 4A illustrates an example system architecture of an access point and a backhaul device.

FIG. 4B illustrates an example system architecture of an AFC server, an access point, and a backhaul device.

FIG. 5A illustrates an example of a backhaul frame of a backhaul device.

FIG. 5B illustrates an example of a signaling aid in combination with a backhaul frame of a backhaul device.

FIG. 6 illustrates a block diagram of an example automated frequency coordination (AFC) system.

FIG. 7 illustrates an example of backhaul modem channelization.

FIG. 8 illustrates an example process flow of an access point configured to compute one or more operating frequency channels.

FIG. 9 illustrates an example process flow of an access point configured to compute one or more operating frequency channels.

FIG. 10 illustrates an example process flow of a backhaul device configured to transmit a downlink signal.

FIG. 11 illustrates an example communication system configured for access point interference reduction.

FIG. 12 illustrates a diagrammatic representation of a machine in the example form of a computing device within which a set of instructions, for causing the machine to perform any one or more of the methods discussed herein, may be executed.

FIG. 13A illustrates an example of the autocorrelation of a backhaul signal received at an AP.

FIG. 13B illustrates an example of the autocorrelation of a backhaul signal received at an AP.

FIG. 13C illustrates an example of the autocorrelation of a backhaul signal received at an AP.

### DESCRIPTION OF EMBODIMENTS

In association with 6 gigahertz (GHz) Wi-Fi® communications, the Federal Communications Commission (FCC) has set forth predicted interference-to-noise (I/N) ratios for 6 GHz receivers (e.g., incumbent systems) that may not exceed −6 dB. In some circumstances, an access point (AP) seeking deployment may demonstrate communications in the 6 GHz frequency band do not exceed −6 dB I/N through lab testing and/or field testing. In some circumstances, the FCC may withhold communication authorization for an AP that has not demonstrated an acceptable I/N ratio.

A backhaul modem may be implemented in a mobile network to connect a cell site to a core network. There are at least two different ways of implementing the backhaul modem: (1) wired (leased lines or copper/fiber), or (2) wireless (e.g., point-to-point, point-to-multipoint). When implemented as a wireless backhaul, different network topologies may be used including microwave bands, mesh and edge network topologies, or the like. Different backhaul technologies may be used including free-space optical, microwave radio relay transmission, microwave access technologies, digital subscriber line (DSL), Ethernet, voice over Internet Protocol (VoIP), or the like.

Backhaul modems may be configured to communicate using the 6 GHz frequency band. Furthermore, an AP may be configured to communicate in the 6 GHz frequency band and may interfere with the backhaul modem or other incumbents. However, government regulations (e.g., as promulgated by the FCC) prohibit excessive interference by the AP with respect to backhaul modems and incumbent devices. Therefore, methods for avoiding interference while continuing wireless transmission in the 6 GHz frequency band may be useful.

To avoid interference with backhaul modems and other incumbents (e.g., fixed service, satellite service, TV and broadcast services), an AP seeking deployment may use a power transmission mode that is less than a predefined threshold when communicating in a frequency channel that may interfere. For example, a low power indoor transmit power mode may be used to avoid interference because the power threshold may not be adequately high to pass through walls to interfere with backhaul modems or other incumbent transmission.

The AP may measure the interference at the AP, and measuring interference at the AP may not provide adequate information to facilitate interference avoidance because: (i) without access to database information, the AP may not know which Rx frequency at the backhaul modem or incumbent may be interfered with, and (ii) without access to AP location information, the AP may avoid the full band and use a low power indoor transmit power mode and may not use a higher transmission power mode (e.g., standard power) because the AP does not know whether the higher transmission power mode may interfere with a device with a location that may be near or far with respect to the AP.

In one example, a backhaul modem may comprise a processing device and a transceiver. The processing device may be configured to compute, at the backhaul modem, a signaling aid configured for detection by an access point (AP). The processing device may be configured to encode, at the backhaul modem, the signaling in combination with a backhaul frame. The processing device may be configured to send, from the backhaul modem for transmission to the AP, a downlink signal including the signaling aid and the backhaul frame to a transceiver. The transceiver may be configured to transmit the downlink signal including the signaling aid and the backhaul frame to the AP.

In another example, an AP may comprise a processing device and a transceiver. The processing device may be configured to detect, at the AP, a backhaul transmission received from a backhaul modem. The processing device may be configured to identify, at the AP, one or more backhaul frequency channels present in the backhaul transmission. The processing device may be configured to compute, at the AP, one or more complementary backhaul frequency channels based on the one or more backhaul frequency channels. The processing device may be configured to compute, at the AP, one or more operating frequency channels, wherein the one or more operating frequency channels do not include: the one or more backhaul frequency channels and the one or more complementary backhaul frequency channels. The transceiver may be configured to transmit, from the AP to a wireless device, a signal using the one or more operating frequency channels.

In another example, an AP may comprise a transceiver configured to receive, at the AP from a backhaul modem, a downlink signal including the signaling aid and the backhaul frame. The AP may comprise a processing device configured to: identify, at the AP, a signaling aid in the downlink signal to detect a downlink backhaul frequency channel; and determine, based on the signaling aid, one or more operating frequencies for the AP, wherein the operating frequencies do not include the backhaul frequency channel.

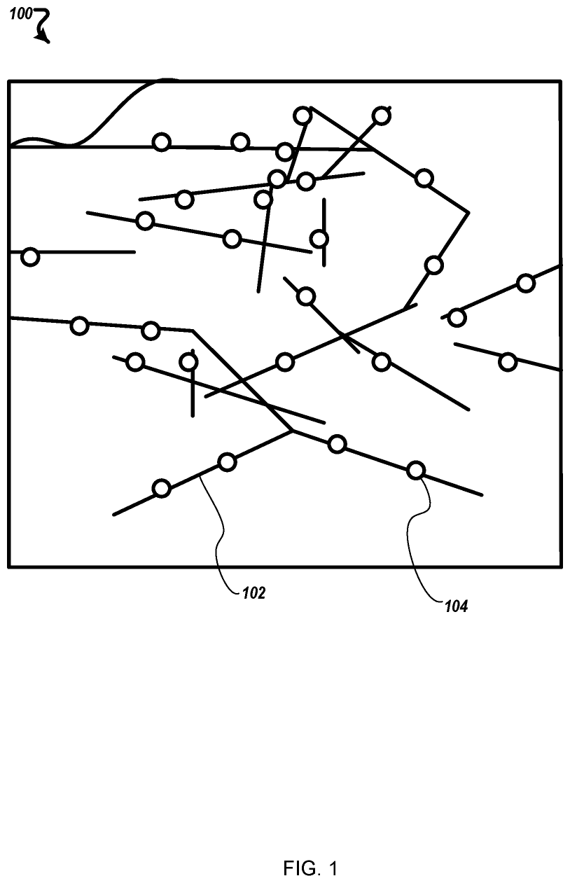

As illustrated in FIG. 1, an example diagram is provided showing service paths (e.g., 102) of microwave links that may be 6 GHz communication systems (e.g., 104) in an example service area 100 (e.g., a specific city). An access point (AP) (e.g., a Wi-Fi® AP configured to operate in a 6 GHz frequency band) may obtain service paths (e.g., 102) associated with incumbent systems (e.g., 6 GHz communication systems 104) in the service area 100 from one or more of an AFC database or by measuring/detecting the service paths (e.g., without using an AFC database). The AP may be configured to determine a distance between the AP and the backhaul device and/or incumbent systems (e.g., 6 GHz communication systems 104). The AP may be configured to determine interference between transmissions from the AP and one or more backhaul devices and/or incumbent systems (e.g., 6 GHz communication systems 104) and the AP may be configured to determine whether to (i) transmit in a standard power mode, (ii) transmit in a low power mode, (iii) transmit in a very low power mode, or (iv) not transmit.

Various regulations and proposals from governmental and industry sources may impact use of the 6 GHz frequency band. The FCC has promulgated regulations affecting the permissible interference to noise (I/N) ratio in the 6 GHz frequency band. For example, the I/N ratio may not exceed −6 decibels (dB) in the 6 GHz frequency band. In some areas of Europe, other interference proposals have been set forth relating to a long term interference criteria in which the I/N ratio may not exceed −10 dB (or alternatively −20 dB) for a selected percentage of time (e.g., 20%). In some areas of Europe, proposals have been set forth such relating to the short-term interference criteria in which the I/N ratio may not exceed 19 dB for greater than 4.5×10⁻⁴% of the time in any month (as a percentage of error seconds).

Industry groups have proposed various differences from these governmental regulations and proposals. These counter proposals to the FCC 6 GHz regulations have been presented by interested parties, such as the Wi-Fi® Alliance (WFA). Some of the counter proposals have included one or more variations to: (1) operational radio bands (e.g., Unlicensed National Information Infrastructure (UNIT) frequency bands), (2) applicability of low power APs, and (3) additional power modes (e.g., transmit power classes).

For example, the WFA has requested an additional 100 MHz to be allocated for use in the UNII-8 frequency band. The UNII-8 frequency band may correspond to communications including frequencies between 6.875 GHz and 7.125 GHz. Other frequency bands that may be included for use in 6 GHz communications include one or more of UNII-5 (5.925 GHz and 6.425 GHz), UNII-6 (6.425 GHz and 6.525 GHz), or UNII-7 (6.525 GHz and 6.875 GHz).

The WFA has also requested removing indoor limitations associated with low-power operation in the 6 GHz frequency band. The FCC, alternatively, has requested limits on the use of low power 6 GHz communications to be indoor.

The WFA has also requested an additional class of 6 GHz communications to operate using very low power. The various transmit power classes may include: (1) standard power transmissions that may include transmissions having a power of up to about 36 dBm, (2) low power transmissions that may include transmissions having a power of up to about 30 dBm, (3) and very low power transmissions that may include transmissions having a power of up to about 14 dBm. As requested by the WFA, the very low power transmit power class may be used in short-range applications (e.g., for portable APs).

The WFA has also requested that client devices (e.g., user equipment receiving wireless communications from the AP) use a transmit power class that matches the transmit power class of the corresponding AP. For example, a client device, that is receiving wireless communications from an AP that is transmitting in a low-power transmit power class, may use low-power transmit power class for wireless communications to the AP.

To comply with this request by the WFA, one or more of the AP or the client device may include a transmit power class control, configured to match the transmit power class used by the client device to the transmit power class used by the AP.

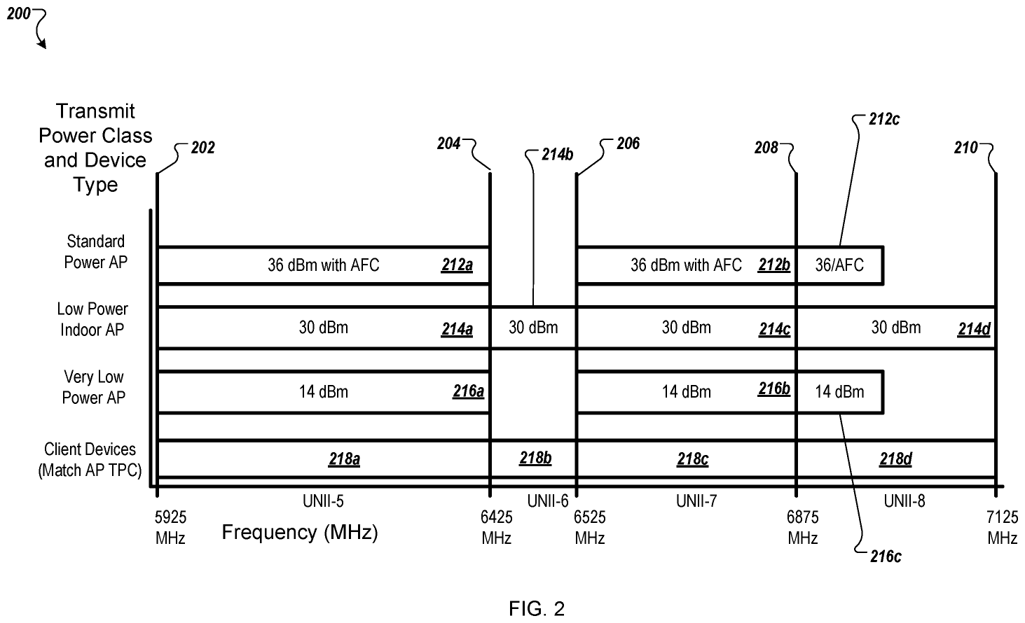

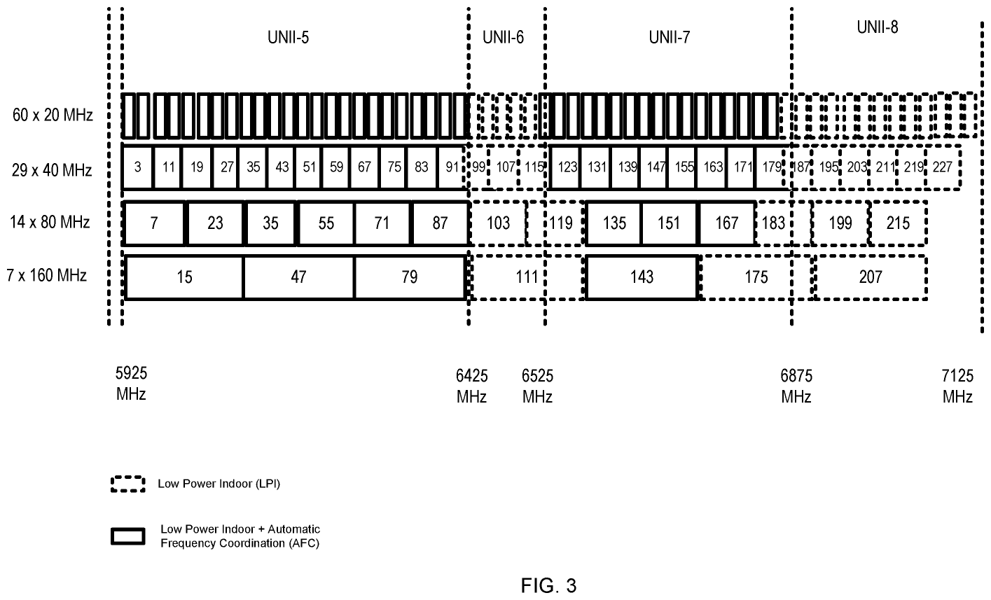

FIG. 2 illustrates some of the counter proposals to the FCC regulations. FIG. 3 and Table I provide a summary of some of the FCC regulations. FIG. 2 provides a graph showing the transmit power class and device type as a function of frequency in megahertz (MHz). The 6 gigahertz (GHz) frequency band may include 4 frequency sub-bands: (i) UNII-5 having a frequency range of from 5925 MHz (202) to 6425 MHz (204), (ii) UNII-6 having a frequency range of from 6425 MHz (204) to 6525 MHz (206), (iii) UNII-7 having a frequency range of from 6525 MHz (206) to 6875 MHz (208), or (iv) UNII-8 having a frequency range of from 6875 MHz (208) to 7125 MHz (210).

When APs are allocated bandwidth by an AFC server, the APs may be permitted to operate using a standard power transmit power class. For standard power APs, the maximum transmit power may be an effective isotropic radiated power (EIRP) of about 36 decibel milliwatts (dBm) for: (a) APs operating within the UNII-5 frequency sub-band, as shown by 212a, (b) for APs operating within the UNII-7 frequency sub-band, as shown by 212b, or (c) for APs operating within a portion of the UNII-8 frequency sub-band, as shown by 212c.

When APs are not allocated bandwidth by an AFC server, the APs may be permitted to operate using a low power indoor (LPI) transmit power class. For APs operating in an LPI transmit power class, the maximum permitted transmit power may be an EIRP of about 30 dBm for: (a) APs operating within the UNII-5 frequency sub-band, as shown by 214a, (b) for APs operating within the UNII-6 frequency sub-band, as shown by 214b, (c) for APs operating within the UNII-7 frequency sub-band, as shown by 214c, or (d) for APs operating within the UNII-8 frequency sub-band, as shown by 214d.

APs operating using the very low power transmit power class, as proposed by WFA, may be used in short-range applications (e.g., for portable APs). For APs operating in a very low power transmit power class, the maximum permitted transmit power may be an EIRP of about 14 dBm for: (a) APs operating within the UNII-5 frequency sub-band, as shown by 216a, (b) for APs operating within a UNII-7 frequency sub-band, as shown by 216b, or (c) for APs operating within a portion of the UNII-8 frequency sub-band, as shown by 216c.

The WFA has further proposed that client devices use a transmit power that match one or more of the transmit power or the transmit power class for the corresponding AP. That is, for client devices that operate in the 6 GHz frequency band, a client device may: (i) match a standard power transmit power class when the corresponding AP uses a standard power transmit power class; (ii) match a low power indoor transmit power class when the corresponding AP uses a low power indoor transmit power class; or (iii) match a very low power transmit power class when the corresponding AP uses a very low power transmit power class. The clients devices may be configured to match the transmit power class for the corresponding AP across the 6 GHz frequency band, as shown by 218a, 218b, 218c, and 218d.

Table I provides an example of the FCC regulations for the 6 GHz frequency band. For a channel bandwidth of from about 20 MHz to about 320 MHz (e.g., for a channel bandwidth of 20 MHz, or 40 MHz, or 80 MHz, or 160 MHz, or 320 MHz), the antenna gain in dBi may be 3 (or a maximum or 6 dBi).

For LPI operation, the maximum power spectral density (PSD) may be fixed at 5 dBm/MHz for a channel bandwidth of from about 20 MHz to about 320 MHz (e.g., for a channel bandwidth of 20 MHz, or 40 MHz, or 80 MHz, or 160 MHz, or 320 MHz). The maximum radio frequency (RF) output power may be: (a) 15 dBm for a channel bandwidth of 20 MHz, (b) 18 dBm for a channel bandwidth of 40 MHz, (c) 21 dBm for a channel bandwidth of MHz, (d) 24 dBm for a channel bandwidth of 160 MHz, or (e) 27 dBm for a channel bandwidth of 320 MHz. The maximum EIRP may be: (a) 18 dBm for a channel bandwidth of 20 MHz, (b) 21 dBm for a channel bandwidth of 40 MHz, (c) 24 dBm for a channel bandwidth of MHz, (d) 27 dBm for a channel bandwidth of 160 MHz, or (e) 30 dBm for a channel bandwidth of 320 MHz.

TABLE I
FCC Regulations Impacting 6 GHz channels in the United States.

| | | Low Power Indoor (LPI) | | | Standard Power AP | |
|---|---|---|---|---|---|---|
| | | | RF | | RF | |
| Channel | Antenna | | Output | | Output | |
| Bandwidth | Gain | PSD (dBm/ | Power | EIRP | Power | EIRP |
| (MHz) | (dBi) | MHz) | (dBm) | (dBm) | (dBm) | (dBm) |
| 20 | 3 | 5 | 15 | 18 | 33 | 36 |
| 40 | 3 | 5 | 18 | 21 | 33 | 36 |
| 80 | 3 | 5 | 21 | 24 | 33 | 36 |
| 160 | 3 | 5 | 24 | 27 | 33 | 36 |
| 320 | 3 | 5 | 27 | 30 | 33 | 36 |

For standard power operation, the maximum RF output power may be 33 dBm for a channel bandwidth of from about 20 MHz to about 320 MHz (e.g., for a channel bandwidth of 20 MHz, or 40 MHz, or 80 MHz, or 160 MHz, or 320 MHz). The maximum EIRP may be 36 for a channel bandwidth of from about 20 MHz to about 320 MHz (e.g., for a channel bandwidth of 20 MHz, or 40 MHz, or 80 MHz, or 160 MHz, or 320 MHz).

FIG. 3 illustrates an example of 6 GHz channels in the United States. When the channel bandwidth is 160 MHz, 7 different channels in the 6 GHz frequency band may be used including: channels 15, 47, and 79 in the UNII-5 sub-band; channel 111 in the UNII-6 and UNII-7 sub-bands; channels 143 in the UNII-7 sub-band; channel 175 in the UNII-7 and UNII-8 sub-bands; and channel 207 in the UNII-8 sub-band. Channels 15, 47, 79, and 143 may be operable in one or more of a low power indoor transmit power class and in a standard power class in coordination with an AFC server. Channels 111, 175, and 207 may be operable in a low power indoor transmit power class.

When the channel bandwidth is 80 MHz, 14 different channels in the 6 GHz frequency band may be used including: channels 7, 23, 39, 55, 71, and 87 in the UNII-5 sub-band; channel 103 in the UNII-6 sub-band; channel 119 in the UNII-6 and UNII-7 sub-bands; channels 135, 151, and 167 in the UNII-7 sub-band; channel 183 in the UNII-7 and UNII-8 sub-bands; channels 199 and 215 in the UNII-8 sub-bands. Channels 7, 23, 35, 55, 71, 87, 135, 151, and 167 may be operable in one or more of a low power indoor transmit power class and in a standard power class in coordination with an AFC server. Channels 103, 119, 183, 199, and 215 may be operable in a low power indoor transmit power class.

When the channel bandwidth is 40 MHz, 29 different channels in the 6 GHz frequency band may be used including: channels 3, 11, 19, 27, 35, 43, 51, 59, 67, 75, 83, and 91 in the UNII-5 frequency sub-band; channels 99 and 107 in the UNII-6 frequency sub-band; channel 115 in the UNII-6 and UNII-7 frequency sub-bands; channels 123, 131, 139, 147, 155, 163, 171, and 179 in the UNII-7 frequency sub-band; channel 187 in the UNII-7 and UNII-8 frequency sub-bands; channels 195, 203, 211, 219, and 227 in the UNII-8 frequency sub-band. Channels 3, 11, 19, 27, 35, 43, 51, 59, 67, 75, 83, 91, 123, 131, 139, 147, 155, 163, 171, and 179 may be operable in one or more of a low power indoor transmit power class and in a standard power class in coordination with an AFC server. Channels 99, 107, 115, 187, 195, 203, 211, 219, and 227 may be operable in a low power indoor transmit power class.

When the channel bandwidth is 20 MHz, 59 different channels in the 6 GHz frequency band may be used including: channels 1, 5, 9, 13, 17, 21, 25, 29, 33, 37, 41, 45, 49, 53, 57, 61, 65, 69, 73, 77, 81, 85, 89, and 93 in the UNII-5 frequency sub-band; channels 97, 101, 105, 109, and 113 in the UNII-6 frequency sub-band; channels 117, 121, 125, 129, 133, 137, 141, 145, 149, 153, 157, 161, 165, 169, 173, 177, and 181 in the UNII-7 frequency sub-band; channel 185 in the UNII-7 and UNII-8 frequency sub-bands; channels 189, 193, 197, 201, 205, 209, 213, 217, 221, 225, 229, and 233 in the UNII-8 frequency sub-band. Channels 1, 5, 9, 13, 17, 21, 25, 29, 33, 37, 41, 45, 49, 53, 57, 61, 65, 69, 73, 77, 81, 85, 89, 93, 117, 121, 125, 129, 133, 137, 141, 145, 149, 153, 157, 161, 165, 169, 173, 177, and 181 may be operable in one or more of a low power indoor transmit power class and in a standard power class in coordination with an AFC server. Channels 97, 101, 105, 109, 113, 185, 189, 193, 197, 201, 205, 209, 213, 217, 221, 225, 229, and 233 may be operable in a low power indoor transmit power class.

Embodiments of the present disclosure will be explained with reference to the accompanying drawings.

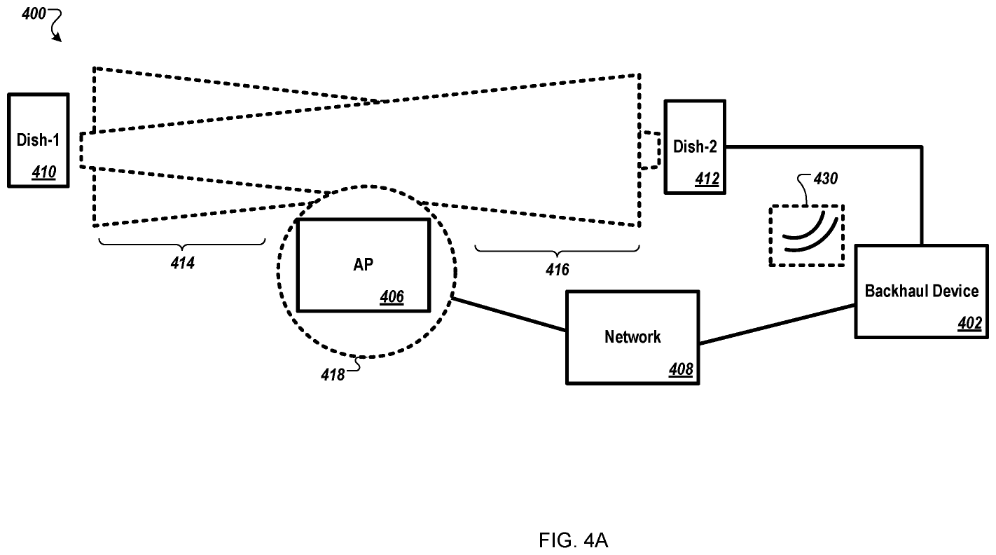

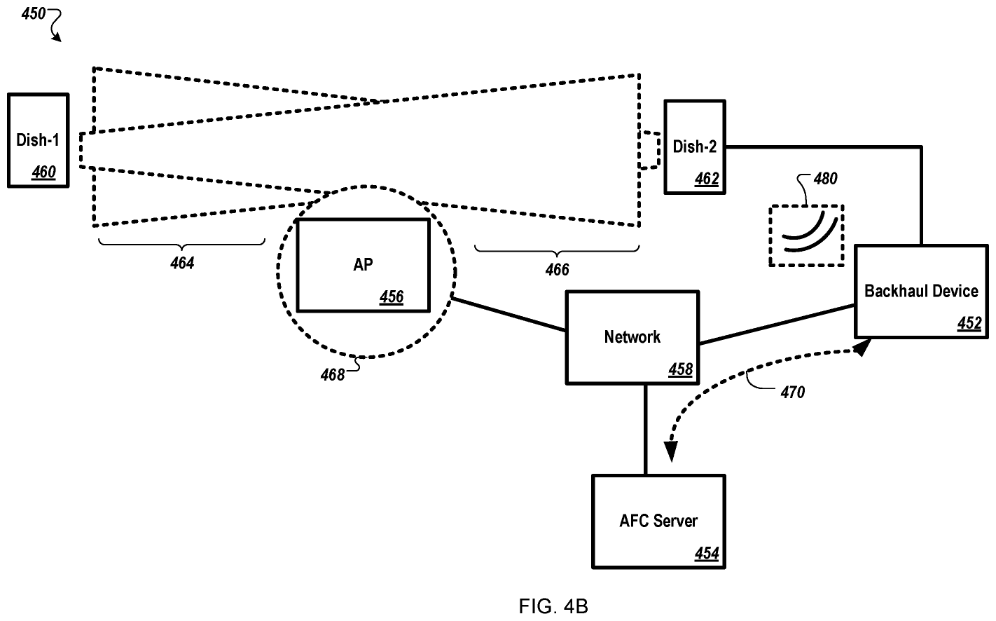

FIG. 4A illustrates an example system architecture 400 for AP interference reduction. The system architecture 400 may comprise a backhaul device 402, an AP 406, a network 408 (e.g., the internet, which may be configured to communicate with an AFC server), a first dish 410, and a second dish 412. The first dish 410 may be configured to communicate a first transmission signal 414 to the second dish 412, and the second dish 412 may be configured to communicate a second transmission signal 416 to the first dish 410. The AP 406 may include a Wi-Fi® AP. The Wi-Fi® AP may be configured to provide Wi-Fi® to devices that may be communicatively coupled to the APs using a 6 GHz frequency band including one or more of the UNII-5, UNII-6, UNII-7, or UNII-8 sub-bands. The AP 406 may be configured to radiate a radiation pattern 418 that may be in between the transmission path between the first dish 410 and the second dish 412. As illustrated, Dish-1 410 and Dish-2 412 may form a microwave link path (e.g., microwave link path 414 and microwave link path 416) in which the AP has a radiation pattern 418 in the communication path. The backhaul device may receive an interfering signal 430 (e.g., an interfering Wi-Fi® signal) from the AP 406.

The backhaul device 402 (e.g., backhaul modem) may comprise a processing device and a transceiver. The processing device may be configured to compute, at the backhaul device 402 (e.g., backhaul modem), a signaling aid configured for detection by an AP 406. A “signaling aid” may be a signal added to a backhaul frame to facilitate detection by an AP (e.g., a Wi-Fi® AP) without being used for detection between backhaul devices (e.g., backhaul modems).

The processing device may be configured to encode, at the backhaul device 402 (e.g., backhaul modem), the signaling aid for combination with a backhaul frame. In one example, the signaling aid may be added to the backhaul frame (e.g., before a backhaul frame) instead of being embedded within (e.g., between different symbols of a backhaul frame) the backhaul frame. The processing device may be configured to send, from the backhaul device 402 (e.g., backhaul modem) for transmission to the AP 406, a downlink signal including the backhaul frame and the signaling aid to a transceiver. The transceiver may be configured to transmit the downlink signal including the backhaul frame and the signaling aid to the AP 406.

The signaling aid may be suitable for facilitating detection by the AP 406 of the backhaul device 402 (e.g., backhaul modem). In one example, the signaling aid may be an AP transmission preamble. The AP transmission preamble may be one or more of: a legacy short training field (L-STF), legacy long training field (L-LTF), or legacy signal field (L-SIG). These transmission preambles may be detected by the AP 406.

The signaling aid may be configured to facilitate detection by the AP 406 without being aligned to a wireless local area network (e.g., Wi-Fi®) raster. In this example, the signaling aid may be detected by a wireless local area network that may be configured to select frequency channels having a low interference by performing a channel availability check (CAC) by using a channel allocation scheme (e.g., dynamic frequency selection (DFS)).

The signaling aid may be configured for detection at a Wi-Fi® AP. That is, the signaling aid may use OFDM modulation and have a carrier spacing that is the same as the carrier spacing of one or more of WiFi® L-STF or WiFi® L-LTF. The modulated sequence may be generated to identify the transmitting device as a backhaul device (e.g., a backhaul modem) instead of a Wi-Fi® AP.

The backhaul device 402 (e.g., a transceiver for the backhaul device 402) may be configured to receive a downlink signal including the signaling aid and the backhaul frame from a different backhaul device (e.g., backhaul modem). The downlink signal, received from the different backhaul device, may include a signaling aid that may not be intended for transmission to the backhaul device 402. When this situation occurs, the processing device for the backhaul device 402 (e.g., backhaul modem) may be configured to identify, at the backhaul device 402 (e.g., backhaul modem), the signaling aid in a downlink signal in which the downlink signal may include a downlink channel having the signaling aid. In this example, the downlink signal may be identified as a downlink signal based on one or more of: a specific frequency channel, a specific resource unit (RU), a backhaul frame structure, a field type, or the signaling aid. In this example, the processing device may be configured to skip, at the backhaul device 402 (e.g., backhaul modem), decoding of the signaling aid by identifying the signaling aid in the downlink channel in the downlink signal. The processing device may be configured to continue decoding the downlink signal after skipping decoding of the signaling aid.

The backhaul device 402 (e.g., backhaul modem) may be configured to transmit the downlink signal using a first backhaul transmit path. The backhaul device 402 (e.g., backhaul modem) may be configured to transmit a second downlink signal comprising a second signaling aid and a second backhaul frame in a second downlink signal using a second backhaul transmit path. The backhaul device 402 (e.g., backhaul modem) may be configured to transmit the downlink signal comprising the one or more additional signaling aids and one or more additional backhaul frames in an alternating pattern from a plurality of different backhaul transmit (Tx) chains to avoid beamforming.

The signaling aid may be inserted into a downlink signal from a backhaul device 402 (e.g., backhaul modem) in any suitable pattern to facilitate detection by an AP 406 (e.g., a Wi-Fi® AP). The pattern may be a periodic pattern in which the signaling aid may be inserted into the downlink signal based on a selected time period (e.g., 20 μs, 40 μs, 80 μs, 200 μs, 1 ms, 5 ms, 50 ms, 200 ms, 1 s, 5 s, 15 s, 30 s, or the like) or a selected number of frame, subframes, or the like. In one example, the processing device may be configured to encode, at the backhaul device 402 (e.g., backhaul modem), the signaling aid in combination with one or more backhaul frames in one or more backhaul signals periodically (e.g., in a periodic pattern based on a selected time period or a selected number of frames, subframes, or the like).

The signaling aid may have a power spectral density (PSD) that may be configured to conform to a backhaul signal PSD. That is, the signaling aid may match the PSD for a downlink signal transmitted from a backhaul device 402 (e.g., backhaul modem). The backhaul device 402 (e.g., backhaul modem) may be configured to pre-compute the signaling aid for insertion in a downlink signal. The backhaul device 402 (e.g., backhaul modem) may be configured to read the precomputed signaling aid from a memory to increase the insertion of the signaling aid in a downlink signal.

The signaling aid may be configured to be detected by an AP 406 in various ways. In one example, the signaling aid may be configured to be detectable by the AP 406 using dynamic frequency selection. The signaling aid may be configured to have a bandwidth of one or more of: 3.5 MHz, 7 MHz, 14 MHz, 28 MHz, or 56 MHz. The AP 406 may be configured to identify the signaling aid to identify the received signal as a backhaul signal.

The AP 406 may be configured to avoid interfering with the backhaul device 402 (e.g., a backhaul modem). The AP 406 may comprise a transceiver configured to receive, at the AP 406 from a backhaul device 402 (e.g., a backhaul modem), a downlink signal. The downlink signal may include a backhaul frame.

The signaling aid may comprise a suitable PPDU that may comprise a transmission vector format including one or more of: extremely high throughput (EHT), wake up radio (WUR), high efficiency (HE), directional multi-gigabit (DMG), sub-1-GHz (SIG), very-high-throughput (VHT), high-throughput (HT), non-HT, or the like. The PPDU may comprise any suitable modulation format including one or more of: direct sequence spread spectrum (DSSS) and complementary code keying (CCK); orthogonal frequency-division multiplexing (OFDM); single carrier and OFDM; orthogonal frequency-division multiple access (OFDMA); multi-carrier on-off keying (MC-OOK), or the like. The PPDU field structure may comprise any suitable field structure including one or more fields including one or more of: legacy short training field (L-STF), legacy long training field (L-LTF), legacy signal field (L-SIG), repeated legacy signal field (RL-SIG), universal signal field (U-SIG), EHT signal field (EHT-SIG), EHT short training field (EHT-STF), EHT long training field (EHT-LTF), EHT data field (EHT-Data), packet extension field (PE), binary phase-shift keying mark 1 field (BPSK-Mark1), BPSK mark 2 field (BPSK-Mark2), WUR synchronization field (WUR-Sync), WUR data field (WUR-Data), HE signal A field (HE-SIG-A), HE short training field (HE-STF), HE long training field (HE-LTF), short training field, channel estimation field (CEF), header, automatic gain control field (AGC), training (TRN), CEFuvv, CEFvuv, first long training field (LTF-1), data short training field (D-STF), signal B field (SIG-B), VHT signal A field (VHT-SIG-A), VHT short training field (VHT-STF), VHT long training field (VHT-STF), VHT signal B field (VHT-SIG-B), HT signal field (HT-SIG), HT short training field (HT-STF), HT long training field (HT-LTF), physical layer convergence protocol (PLCP) service data unit (PSDU), or the like. In one example, the PPDU may comprise one or more of an HE transmission vector format, an OFDMA modulation format, or an HE PPDU field structure.

The AP 406 may comprise a processing device configured to identify, at the AP 406, a signaling aid in the downlink signal to detect a downlink backhaul frequency channel. A downlink backhaul frequency channel may be a downlink transmission from a backhaul device 402 (e.g., a backhaul modem) to the AP 406 carried on a frequency channel. The processing device, at the AP 406, may be configured to determine, based on the signaling aid, one or more operating frequencies for the AP 406.

When detecting the signaling aid, the AP 406 may detect the interference in a downlink direction (e.g., from the backhaul device 402 to the AP 406). This detected interference in the downlink direction may not allow the AP 406 to avoid interference in the uplink direction unless the AP 406 is configured to compute the interference in the uplink direction based on interference in the downlink direction. In one example, the one or more operating frequencies may be selected to not include one or more of: (i) the downlink backhaul frequency channel, or (ii) a complementary uplink backhaul frequency channel.

The AP 406 may be configured to transmit, using a transceiver, in various transmit power modes. When the AP 406 does not have adequate location data (e.g., for the AP 406, for the backhaul device 402, such as a backhaul modem, or for other backhaul devices, or incumbent devices), then the AP 406 may be configured to transmit in a low power indoor (LPI) transmit power mode. When the AP 406 has adequate location data, then the AP 406 may be configured to transmit in a standard power transmit power mode. When the AP 406 does not have access to a complementary (e.g., uplink) backhaul frequency channel (e.g., a frequency channel on which the backhaul device 402 may be configured to receive transmissions and that the AP 406 may generate interference toward), then the AP 406 may be configured to transmit in an LPI transmit power mode. When the AP 406 does have access to the complementary (e.g., uplink) backhaul frequency channel, which may be communicated to the AP 406 via a database such as an AFC database, then the AP 406 may be configured to transmit in one or more of an LPI transmit power mode (when the AP does not have AP location information) or a standard power transmit power mode (when the AP does have AP location information).

The AP 406 may comprise a receiver that may be configured to search for a downlink signal (e.g., carried on a downlink backhaul frequency channel). The receiver may be configured to search for the downlink signal using a specific channel allocation scheme to avoid interference between the AP 406 and a backhaul device 402 (e.g., a backhaul modem). In one example, the channel allocation scheme may be dynamic frequency selection (DFS).

The signaling aid may be configured to be aligned to an AP raster or may be configured without being aligned to an AP raster. When the signaling aid is configured to be aligned to an AP raster, the signaling aid may comprise an AP transmission preamble. The AP transmission preamble may comprise any suitable preamble field (e.g., L-STF, L-LTF, L-SIG, or the like) configured to operate with a suitable transmission vector format (e.g., HE) and modulation (e.g., OFDMA).

The AP 406 (e.g., at a processor) may be configured to determine a clear channel assessment (CCA) busy indication based on the AP transmission preamble. That is, the AP 406 may detect the AP transmission channel in one or more channels which may cause a CCA operation to indicate that the one or more channels are busy. The CCA busy indication may be based on a channel busy condition in which the received signal strength may exceed a threshold for a particular operating class (e.g., using a CCA energy detect (CCA-ED)). Based on the CCA busy indication, the AP 406 (e.g., at the processor) may be configured to determine one or more operating frequency channels for the AP 406. The AP 406 may determine the one or more operating channels for the AP 406 by removing the one or more channels that cause a CCA busy indication. Based on the CCA busy indication, the AP 406 may be configured to determine a complementary frequency channel (e.g., an uplink frequency channel) so that the AP 406 may avoid interference toward the backhaul device 402 (e.g., a backhaul modem).

The AP 406 may be configured to avoid interfering with a backhaul device 402 (e.g., a backhaul modem) or a different device. The AP 406 may comprise a processing device configured to detect, at the AP 406, a backhaul transmission received from a backhaul device 402 (e.g., a backhaul modem). The processing device may be configured to identify one or more backhaul frequency channels present in the backhaul transmission. The processing device may be configured to compute one or more complementary (e.g., uplink) backhaul frequency channels based on the one or more backhaul frequency channels. That is, the processing device may compute uplink backhaul frequency channels that complement the downlink backhaul frequency channels.

The AP 406 may be configured to compute one or more operating frequency channels to avoid interference between the AP 406 and a backhaul device 402 (e.g., a backhaul modem), an incumbent device, or any other device that may be protected from interference. The one or more operating frequency channels may be selected to not include: (i) the one or more backhaul frequency channels and (ii) the one or more complementary (e.g., uplink) backhaul frequency channels.

The AP 406 may comprise a transceiver that may be configured to transmit, from the AP 406 to a wireless device (e.g., a user equipment (UE) or a suitable device configured to communicate using a wireless local area network (WLAN)), a signal using the one or more operating frequency channels. The one or more operating channels, which may be selected to avoid interfering with the backhaul device 402 (e.g., the backhaul modem), may be transmitted using any suitable transmit power mode to avoid interference with the backhaul device 402 (e.g., the backhaul modem).

The AP 406 may be configured to identify the one or more backhaul frequency channels present in the backhaul transmission using various operations. The processing device may be configured to compute, at the AP 406, an autocorrelation of the backhaul transmission to determine when a carrier signal is present. The processor may be configured to determine when a single carrier modulated signal (e.g., a quadrature amplitude modulation (QAM) signal) is present. The presence of a carrier signal may be determined by using the autocorrelation of the signal to identify a pulse shape (e.g., a root-raised-cosine pulse). If the AP 406 does not have the carrier frequency, then the AP 406 may compute the autocorrelation of the backhaul transmission in a plurality of different frequencies within the one or more channels present in the backhaul transmission.

The AP 406 may be configured to determine a presence in the backhaul transmission of a modulation (e.g., a selected number of quaternary phase shift keying (QPSK) symbols or a different low-order modulation). The carrier frequency may be determined based on the autocorrelation of the backhaul transmission. The symbol rate may be determined based on the pulse shape of the autocorrelation. The modulation, as determined based on the carrier frequency and the pulse shape, may be used to validate the backhaul transmission to facilitate interference avoidance by the AP 406. Alternatively, or in addition, the AP 406 may be configured to determine a preamble repetition to validate the backhaul transmission.

The AP 406 may be configured to compute backhaul interference in the one or more backhaul frequency channels by correlating one or more of a backhaul preamble or a backhaul pilot sequence to the backhaul transmission (which may use one or more of information from a database or AP location information). The AP 406 may be configured to detect the backhaul transmission and identify one or more of a backhaul preamble or a backhaul pilot sequence in the backhaul transmission. The backhaul preamble may be a preamble specific to the operation of the backhaul device 402 (e.g., the backhaul modem) without being previously configured to include an AP transmission preamble or other signaling aid. The backhaul pilot sequence may be a pilot sequence specific to the operation of the backhaul device 402 (e.g., the backhaul modem).

When the backhaul device 402 (e.g., the backhaul modem) is using multiple input multiple output (MIMO), cross-polarization interference canceling (XPIC), or the like, then the signal to noise ratio at the transmitter of the backhaul device 402 (e.g., the backhaul modem) may be less than or equal to 0 dB. The AP may be configured to use the signal parameters of the nearby backhaul links received from an AFC server to identify one or more of a backhaul preamble or a backhaul pilot sequence in the backhaul transmission using correlation to avoid interference between the AP and the backhaul device 402 (e.g., the backhaul modem).

As illustrated in FIG. 4B, an example system architecture 450 for AP interference reduction may include an automated frequency coordination (AFC) server 454. The system architecture 450 may comprise a backhaul device 452, an AP (e.g., a Wi-Fi® AP) 456, a network 458 (e.g., the internet, which may be configured to communicate with the AFC server 454), a first dish 460, and a second dish 462. The backhaul device 452 may be configured to communicate with the AFC server via a connection 470. The first dish 460 may be configured to communicate a first transmission signal 464 to the second dish 462, and the second dish 462 may be configured to communicate a second transmission signal 466 to the first dish 460. The AP 456 may be configured to radiate a radiation pattern 468 that may be in between the transmission path between the first dish 460 and the second dish 462. The backhaul device 452 may receive an interfering signal 480 (e.g., an interfering Wi-Fi® signal) from the AP 406.

The AP 456 may comprise a processing device configured to acquire, from an AFC server 454, one or more signal parameters for the one or more backhaul frequency channels. The processing device may be configured to determine backhaul interference in the one or more backhaul frequency channels based on the signal parameters. The processing device may be configured to adjust the one or more operating channels based on the backhaul interference in the one or more backhaul frequency channels. The processing device may be configured to compute one or more of an AP location or a backhaul location based on one or more signal parameters for the one or more backhaul frequency channels.

The AP 456 may be configured in accordance with an interference protection criteria. The AP 456 may be configured to receive one or more interference protection parameters from an AFC server 454. The one or more interference protection parameters may include one or more of propagation models based on exclusion zones and adjacent frequency channel operations. The AP 456 may be configured to avoid selected frequencies within an exclusion zone. The exclusion zone may be defined based on one or more of the I/N ratio, the ratio of the carrier to interference power (C/I) ratio in which the interference may be the signal from the AP 456. The carrier may be the signal strength of the received backhaul device 452 transmission and the noise may be the background noise level. In one example, the interference protection criterion may be a −6 dB I/N ratio which may be used in determining an exclusion zone (e.g., an area in which the AP 456 may not transmit in a transmit power class on a selected frequency channel).

The AP 456 may be configured to access an AFC server 454 to determine a power mode (e.g., standard power, low power indoor, very low power, or the like) based on the predicted interference. The AP 456 may comprise a transceiver configured to transmit a signal using the one or more operating channels at the power mode. In some examples, the power mode for the AP may be selected to facilitate a predicted interference of less than a predicted I/N ratio. The predicted I/N ratio may be less than any suitable threshold as set forth by a regulatory authority or a governmental entity (e.g., −6 dB as set forth by the FCC for Wi-Fi® communications in the 6 GHz frequency band).

The AFC server 454 may be configured to be in communication with a data storage (e.g., an AFC database). The data storage may comprise backhaul device data for backhaul device.

The AFC server 454 may be configure to receive AP device data from the AP 456. In one example, the AFC server 454 may be configured to an AP identifier from the AP 456. The AFC server 454 may be configured to receive any suitable device data for the AP 456 from the AP 456 including one or more of: a request identifier (e.g., RequestID), AP device description data (e.g., a serial number, a certification identifier, a rule set identifier), AP location data (e.g., elliptical location data such as center longitude, center latitude, majorAxis, minorAxis, or orientation; elevation location data such as height, height type, or vertical uncertainty; or indoor deployment data), an inquired frequency range (e.g., a low frequency and a high frequency in a frequency range in the 6 GHz frequency band), inquired channel data, or the like. In one example, the AP device data may include one or more of: a geolocation, a location confidence, an antenna height, an FCC identifier (ID), a serial number, interference data, distortion data, noise power data, environmental data, or the like.

The AFC server 454 may be configured to receive an interference level between the AP 456 and the one or more backhaul devices 452 from the AP 456. In some examples, the AFC server 454 may be configured to compute an I/N ratio for the backhaul device 452. In some examples, the AFC server 454 may be configured to compute one or more operating frequencies for an AP 456. The one or more operating frequencies may have an I/N ratio of less than a threshold at the backhaul device 452.

The AP 456 may comprise a processing device that may be configured to determine interference between the AP 456 and the backhaul device 452. The AP 456 may be configured to determine a distance between the AP 456 and the backhaul device 452. Determining a distance between the AP 456 and the backhaul device 452 may include determining a location of the AP 456.

The AP 456 may share its location to receive permission from the AFC server 454 to perform various operations, including to use standard power Wi-Fi® transmission in the 6 GHz frequency band. To determine the location of the AP 456, a geolocation may be determined, such as by using a global positioning service (GPS) location of the AP 456. The AP 456 may be configured to send, from the AP 456 for transmission to an AFC server 454, the AP location and receive, at the AP 456 from the AFC server 454, a transmission power mode permission (e.g., to operate in a transmit power class). The AP 456 may be configured to determine a transmission power mode based on a power setting permission. The transmission power mode may be one or more of: (i) a non-transmitting power mode, (ii) a very low power mode, (iii) a low power mode, or (iv) a standard power mode. The AP 456 may comprise a transceiver that may be configured to receive additional operating frequencies from an AFC server 454. The transceiver may be configured to receive one or more of an AP location or a backhaul location from the AFC server 454.

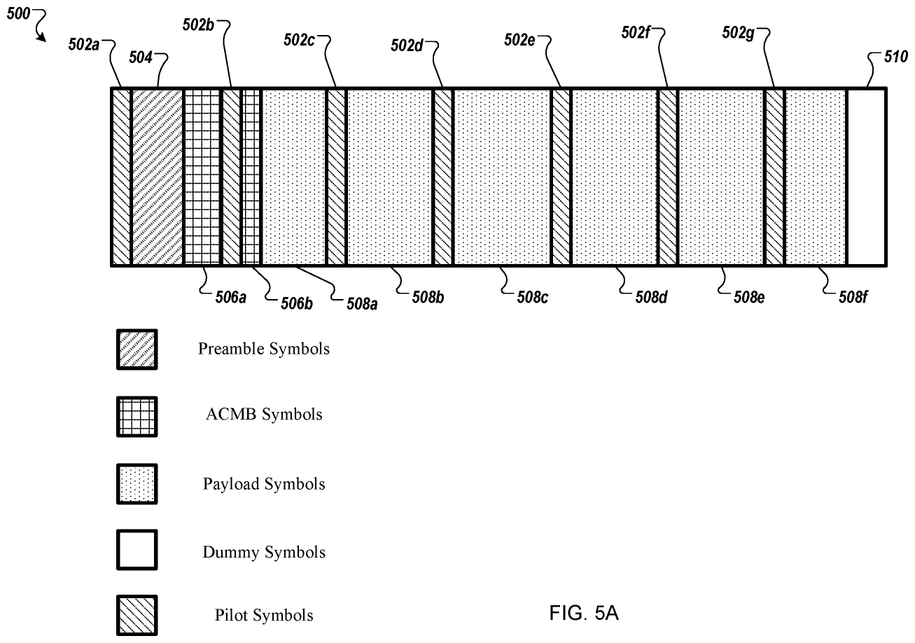

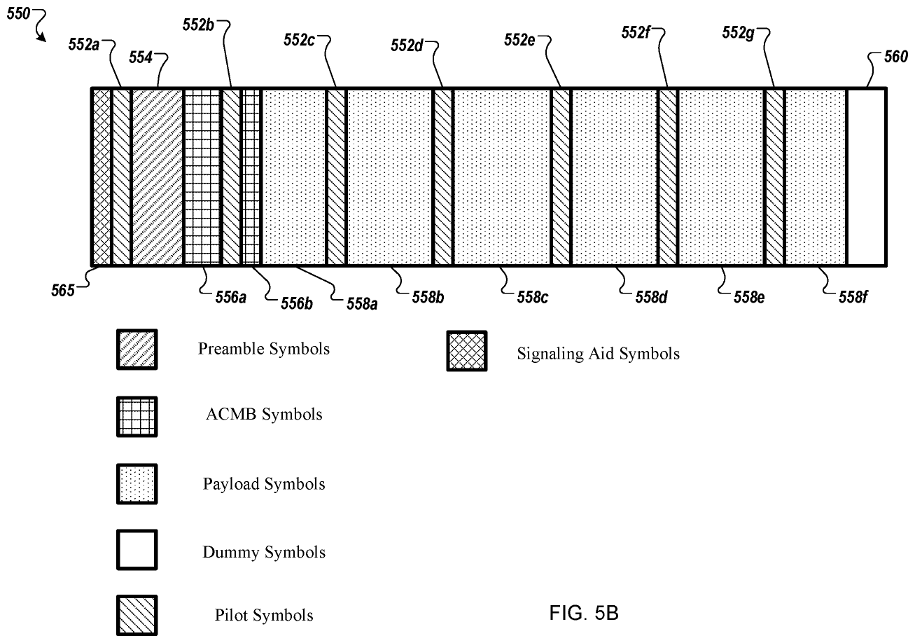

FIG. 5A illustrates a block diagram of an example frame structure 500 for a backhaul transmission which may be detected at an AP. The AP may detect the backhaul transmission, or another device may detect the backhaul transmission. To detect the backhaul transmission at the AP, pilot symbols or preamble symbols may be inserted into the frame structure. As illustrated, pilot symbols 502a, 502b, 502c, 502d, 502e, 502f, 502g may be inserted into the example frame structure 500 for detection at an AP. The pilot symbols 502a, 502b, 502c, 502d, 502e, 502f, 502g may be inserted periodically (e.g., periodically in 20 to 40 data symbols). Alternatively, or in addition, preamble symbols 504 may be inserted. The frame structure may comprise various other fields including adaptive code modulation and baud rate (ACMB) symbols 506a, 506b, payload symbols 508a, 508b, 508c, 508d, 508e, 508f, dummy symbols 510, or the like.

FIG. 5B illustrates a block diagram of an example backhaul frame structure 550 for a backhaul transmission which includes a signaling aid that may be detected at an AP. The backhaul frame structure 550 may include pilot symbols 552a, 552b, 552c, 552d, 552e, 552f, 552g, preamble symbols 554, ACMB symbols 556a, 556b, 558a, 558b, 558c, 558d, 558e, 558f, and dummy symbols 560. The signaling aid may comprise signaling aid symbols 565 that may be added to the backhaul frame structure. The signaling aid symbols 565 are added to the backhaul frame structure to facilitate detection by an AP (e.g., a Wi-Fi® AP).

The signaling aid symbols 565 may be configured for detection at a Wi-Fi® AP. The signaling aid symbols may be modulated using OFDM and may have a carrier spacing that is the same as the carrier spacing of one or more of WiFi® L-STF or WiFi® L-LTF. The modulated sequence may be generated to identify the transmitting device as a backhaul device (e.g., a backhaul modem) instead of a Wi-Fi® AP. In one example, the signaling aid symbols 565 may comprise a Wi-Fi® AP preamble to be detected at an AP (e.g., a Wi-Fi® AP).

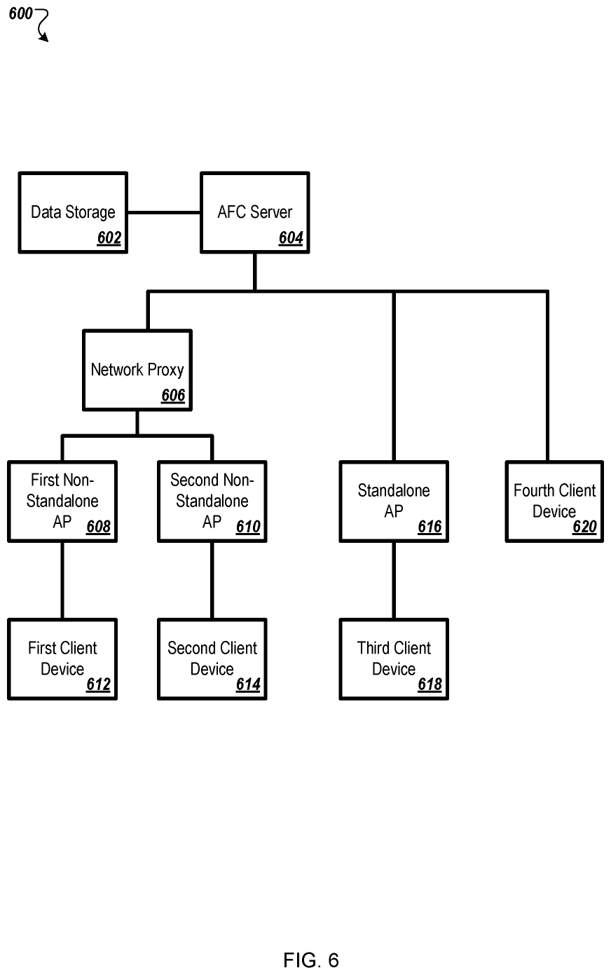

FIG. 6 illustrates a block diagram of an example automated frequency coordination (AFC) architecture 600, in accordance with at least one example described in the present disclosure. The AFC architecture 600 may include a data storage 602, an AFC server 604, a network proxy 606, a first non-standalone AP 608, a second non-standalone AP 610, a standalone AP 616, referred to collectively as the APs, a first client device 612, a second client device 614, a third client device 618, and a fourth client device 620. The AFC server 604 may be a system that determines and provides lists of frequencies that are available for use by access points operating in the 6 GHz frequency band. The network proxy 606 may be a first example of a device configured to access the AFC server 604, the standalone AP 616 may be a second example of a device configured to access the AFC server 604, and the fourth client device 620 may be a third example of a device configured to access the AFC server 604.

The data storage 602 may be an AFC database (i.e., a database configured to interface with the AFC server 604). The AFC database may comprise one or more of a universal licensing system (ULS) database or an equipment authorization system (EAS) database. The AFC database may include incumbent data. In one example, the incumbent data may include a list of incumbent systems or incumbent devices that may be configured to transmit using 6 GHz communications. For example, the ULS database may include a collection of licenses issued for communications using 6 GHz communications, such as a list of microwave links configured to transmit using a frequency between 5925 MHz and 7125 MHz (e.g., UNII-5 frequency band through UNII-8 frequency band). Incumbents may include e.g., fixed service, satellite service, TV, and other broadcast services. In some examples, the data storage may be managed by a regulatory agency, such as the FCC.

The AFC database may include incumbent device data for one or more incumbent devices. The incumbent device data may include one or more of: a request identifier (e.g., RequestID), incumbent device description data (e.g., a serial number, a certification identifier, a rule set identifier), location data (e.g., elliptical location data such as center longitude, center latitude, majorAxis, minorAxis, or orientation; elevation location data such as height, height type, or vertical uncertainty; or indoor deployment data), an inquired frequency range (e.g., a low frequency and a high frequency in a frequency range in the 6 GHz frequency band), inquired channel data, or the like. In one example, the incumbent device data may include one or more of: a geolocation, a location confidence, an antenna height, an FCC identifier (ID), a serial number, interference data, distortion data, noise power data, environmental data, or the like.

The AFC server 604 may be configured to obtain at least a portion of data from the data storage 602. For example, the AFC server 604 may be configured to obtain one or more microwave links, such as from one or more of an incumbent system or an incumbent device. The microwave links may be obtained from within a geographic area (e.g., within a selected range).

Alternatively or in addition, the AFC server 604 may be configured to receive operational characteristics from a device such as e.g., an access point (a first non-standalone AP 608 or a second non-standalone AP 610 via a network proxy 606, a standalone AP 616) or a client device (e.g., a first client device 612 or second client device 614 via the first non-standalone AP 608 or the second non-standalone AP 610, respectively, via the network proxy 606; or a third client device 618 via the standalone AP 616; or a fourth client device 620). Alternatively, or additionally, the AFC server 604 may be configured to receive operational characteristics from one or more receivers in the networks, such as a microwave receiver or a backhaul receiver.

The operational characteristics may include any suitable characteristics used in one or more of allocating bandwidth to a device or avoiding interference between incumbent systems/devices and another device that may be stored in the data storage 602. The operational characteristics may include one or more of: a request identifier (e.g., RequestID), incumbent device description data (e.g., a serial number, a certification identifier, a rule set identifier), location data (e.g., elliptical location data such as center longitude, center latitude, majorAxis, minorAxis, or orientation; elevation location data such as height, height type, or vertical uncertainty; or indoor deployment data), an inquired frequency range (e.g., a low frequency and a high frequency in a frequency range in the 6 GHz frequency band), inquired channel data, a geolocation, a location confidence, an antenna height, an FCC identifier (ID), a serial number, interference data, distortion data, noise power data, environmental data, or the like.

The AFC server 604 may be configured to determine one or more of estimates or measurements of one or more of distortion, interference, noise power, or the like for any suitable component in the architecture 600 such as APs (e.g., first non-standalone AP 608, second non-standalone AP 610, standalone AP 616, or the like) or any other suitable component such as radios, microwave systems, microwave modems, microwave receivers, or the like.

The AFC server 604 may be configured to provide one or more operating frequencies to a device (e.g., a Wi-Fi® AP) to avoid an interference condition. In one example, the operating frequencies may not cause an I/N ratio of greater than a threshold (e.g., −6 dB in accordance with an FCC regulation). For example, the AFC server 604 may determine that a first frequency in the 6 GHz frequency band may cause an I/N ratio of less than a threshold (e.g., less than −6 dB) at an incumbent system, and the AFC server 604 may provide the first frequency in the 6 GHz frequency band to the device (e.g., a Wi-Fi® AP) to be used as an operating frequency.

The AFC server 604 may be configured to provide one or more operating frequencies to a device (e.g., a Wi-Fi® AP) to avoid a time-based interference condition. In one example, the time-based interference condition may prohibit an I/N ratio that exceeds a threshold (e.g., 19 dB) for more than a selected percentage of time (e.g., for more than 4.5×10⁻⁴%) in a selected time period (e.g., a day, a week, a month, or the like). In another example, the time-based interference condition may prohibit an I/N ratio that exceeds a threshold (e.g., −10 dB, −20 dB, or the like), for a selected percentage of time (e.g., 20%) in a selected time period (e.g., a day, a week, a month, or the like).

The AFC server 604 may be configured to compute or estimate an interference to noise (I/N) ratio for the incumbent device based on the mean square error (MSE) value for the incumbent device. The actual I/N impact at a microwave receiver may not be available to the AFC server 604. The AFC server 604, a governmental entity, or a regulatory entity (e.g., the FCC) may rely on offline feedback, such as MSE values, to determine compliance with the I/N ratio. In addition to determining compliance with the regulation (e.g., the FCC regulation to avoid an I/N ratio of greater than −6 dB), the techniques described herein may be used to provide historical data for debugging (e.g., debug views like spectrum waterfall) and maintenance.

Modifications, additions, or omissions may be made to the AFC server 604 without departing from the scope of the present disclosure. For example, in some examples, the AFC server 604 may include any number of other components that may not be explicitly illustrated or described.

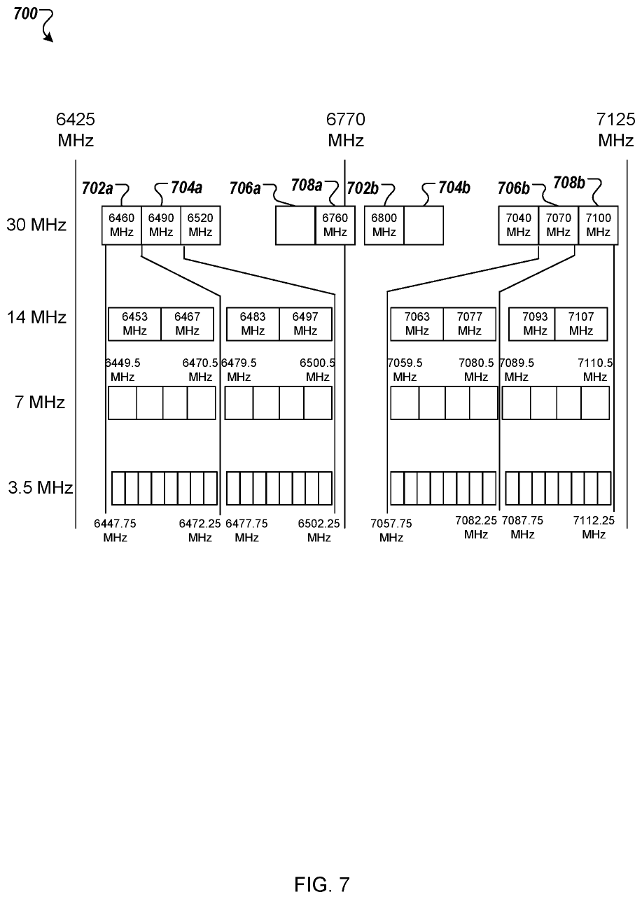

As illustrated in FIG. 7, the backhaul modem channelization 700 is provided for the bandwidth between 6425 MHz and 7125 MHz with respect to the combined spectrum occupancy for channel bandwidths of 3.5 MHz, 7 MHz, 14 MHz, and 30 MHz. The downlink (e.g., transmitted from the backhaul device) and uplink (e.g., received at the backhaul device) frequencies are paired based on the frequency offset which may vary based on the bandwidth range and the bandwidth of the channel. For a frequency range between 6425 MHz and 7125 MHz, the bandwidth for a channel may be one or more of: 3.5 MHz, 7 MHz, 14 MHz, 20 MHz, 30 MHz, or MHz.

In the example of a 30 MHz bandwidth channel in the frequency range of from 6425 MHz to 7125 MHz, a first channel may have a center frequency that is offset from the center frequency of a second frequency. The difference between the center frequency of the first channel and the center frequency of the second channel may be used to determine an uplink channel based on a downlink channel or to determine a downlink channel based on an uplink channel.

Various frequency channels may be paired as uplink and downlink channels which may facilitate determination by an AP of a transmitting frequency channel that may interfere with a backhaul device by detecting the complementary received channel at the AP. A frequency channel 702a (having a center frequency of 6460 MHz) may be paired with a frequency channel 702b (having a center frequency of 6800 MHz). That is, detecting the frequency channel 702a at an AP may allow an AP to determine that the frequency channel 702b is the receiving frequency channel for the backhaul device. In addition, other pairs between frequency channels may be provided including: frequency channel 704a (having a center frequency of 6490 MHz) and frequency channel 704b (having a center frequency of 6830 MHz); frequency channel 706a (having a center frequency of 6700 MHz) and frequency channel 706b (having a center frequency of 7070 MHz); channel 708a (having a center frequency 6760 MHz) and frequency channel 708b (having a center frequency of 7100 MHz); and so forth. Frequency channels having bandwidths of 14 MHz, 7 MHz, and 3.5 MHz may be provided and may have paired frequencies providing a correspondence between downlink and uplink frequency channels.

Frequency channels may be paired for frequency channels in a frequency range of from 5925 MHz to 6425 MHz. The bandwidth of the channels in this frequency range of from 5925 MHz to 6425 MHz may be one or more of 5 MHz, 10 MHz, 20 MHz, 29.65 MHz, 40 MHz, or 59.3 MHz. For frequency channels in this frequency range of from 5925 MHz to 6425 MHz, the frequency offset between the downlink and uplink channels may be one or more of: 240 MHz, 252.04 MHz, 260 MHz, or 266 MHz. Consequently, the frequency offset between complementary uplink and downlink channels may vary based on the frequency range that the complementary channels are in (e.g., 5925-6425 MHz or 6425-7125 MHz) and the bandwidth of the complementary channels (e.g., 3.5 MHz, 7 MHz, 14 MHz, 30 MHz, or the like).

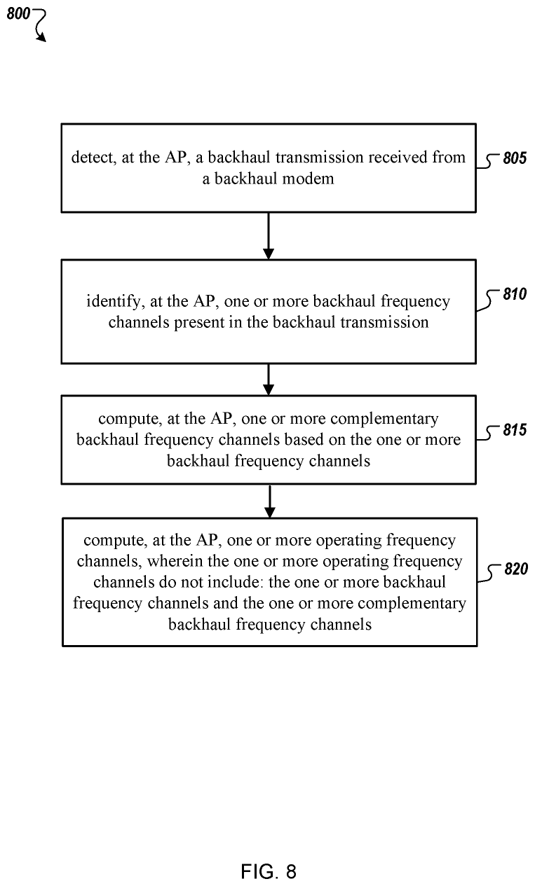

FIG. 8 illustrates a process flow of an example method 800 of AP interference reduction, in accordance with at least one example described in the present disclosure. The method 800 may be arranged in accordance with at least one example described in the present disclosure.

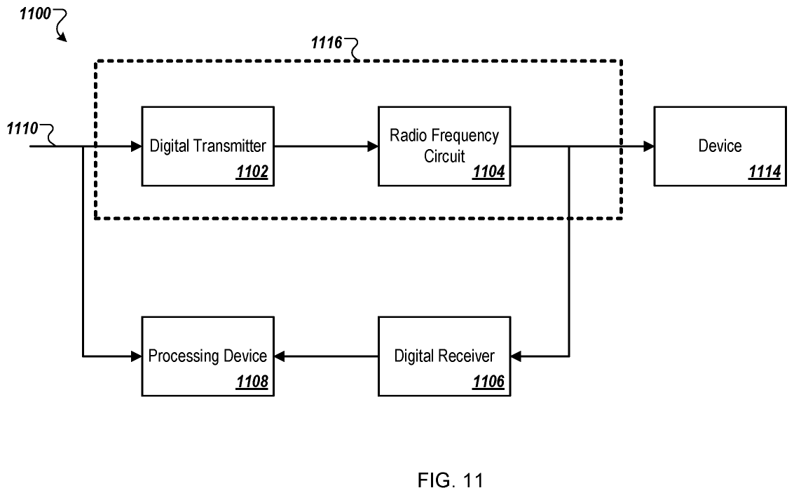

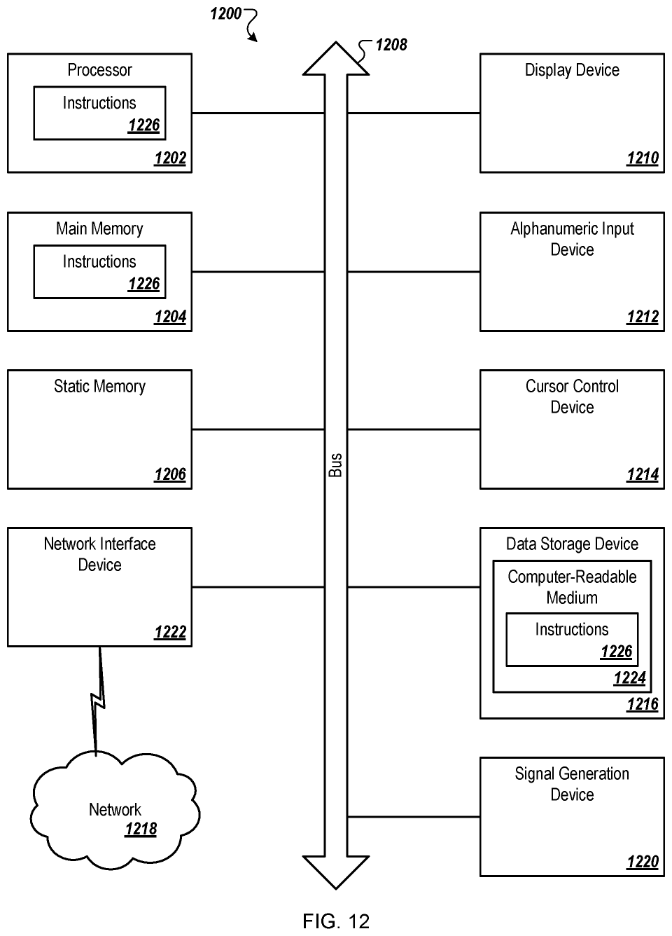

The method 800 may be performed by processing logic that may include hardware (circuitry, dedicated logic, etc.), software (such as is run on a computer system or a dedicated machine), or a combination of both, which processing logic may be included in the processor 1202 of FIG. 12, the communication system 1100 of FIG. 11, or another device, combination of devices, or systems.

The method 800 may begin at block 805 where the processing logic may detect, at the AP, a backhaul transmission received from a backhaul modem.

At block 810, the processing logic may identify, at the AP, one or more backhaul frequency channels present in the backhaul transmission.

At block 815, the processing logic may compute, at the AP, one or more complementary backhaul frequency channels based on the one or more backhaul frequency channels.

At block 820, the processing logic may compute, at the AP, one or more operating frequency channels, wherein the one or more operating frequency channels do not include: the one or more backhaul frequency channels and the one or more complementary backhaul frequency channels.

Modifications, additions, or omissions may be made to the method 800 without departing from the scope of the present disclosure. For example, in some examples, the method 800 may include any number of other components that may not be explicitly illustrated or described.

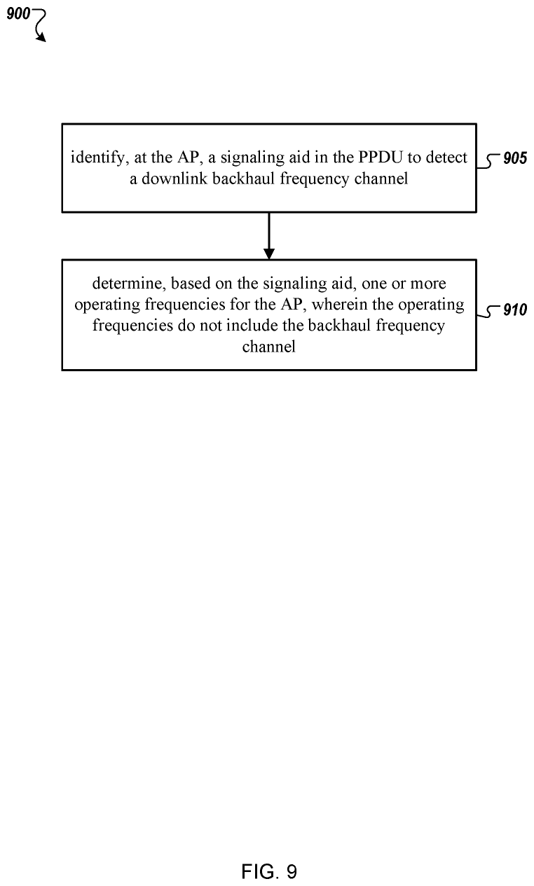

FIG. 9 illustrates a process flow of an example method 900 that may be used for AP interference reduction, in accordance with at least one example described in the present disclosure. The method 900 may be arranged in accordance with at least one example described in the present disclosure.

The method 900 may be performed by processing logic that may include hardware (circuitry, dedicated logic, etc.), software (such as is run on a computer system or a dedicated machine), or a combination of both, which processing logic may be included in the processing device 1202 of FIG. 12, the communication system 1100 of FIG. 11, or another device, combination of devices, or systems.

The method 900 may begin at block 905 where the processing logic may access an automatic frequency coordination (AFC) server to identify, at the AP, a signaling aid in the downlink signal to detect a downlink backhaul frequency channel.

At block 910, the processing logic may determine, based on the signaling aid, one or more operating frequencies for the AP, wherein the operating frequencies do not include the backhaul frequency channel.

Modifications, additions, or omissions may be made to the method 900 without departing from the scope of the present disclosure. For example, in some examples, the method 900 may include any number of other components that may not be explicitly illustrated or described.

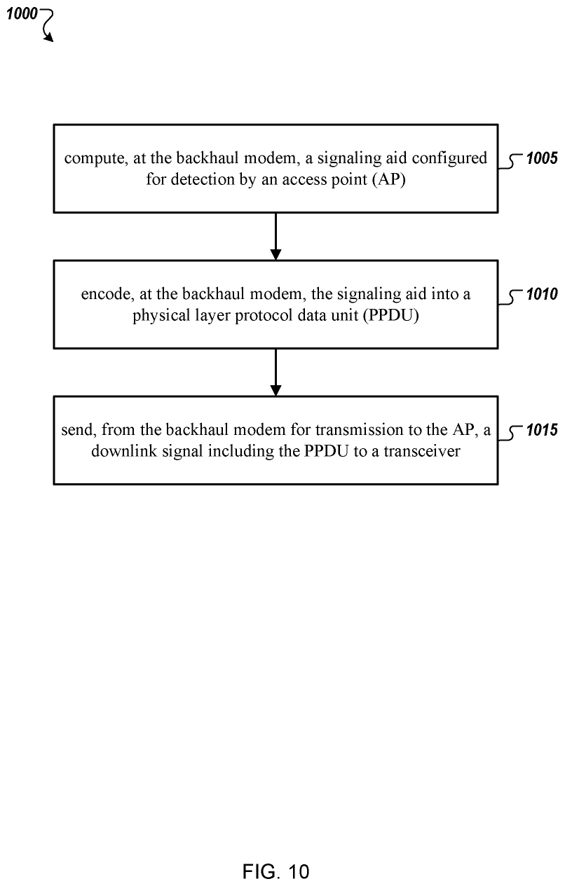

FIG. 10 illustrates a process flow of an example method 1000 that may be used for AP interference reduction, in accordance with at least one example described in the present disclosure. The method 1000 may be arranged in accordance with at least one example described in the present disclosure.

The method 1000 may be performed by processing logic that may include hardware (circuitry, dedicated logic, etc.), software (such as is run on a computer system or a dedicated machine), or a combination of both, which processing logic may be included in the processing device 1202 of FIG. 12, the communication system 1100 of FIG. 11, or another device, combination of devices, or systems.

The method 1000 may begin at block 1005 where the processing logic may compute, at the backhaul modem, a signaling aid configured for detection by an access point (AP).

At block 1010, the processing logic may encode, at the backhaul modem, the signaling aid in combination with a backhaul frame.

At block 1015, the processing logic may send, from the backhaul modem for transmission to the AP, a downlink signal including the signaling aid and the backhaul frame to a transceiver.

Modifications, additions, or omissions may be made to the method 1000 without departing from the scope of the present disclosure. For example, in some examples, the method 1000 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 11 illustrates a block diagram of an example communication system 1100 configured for AP interference reduction, in accordance with at least one example described in the present disclosure. The communication system 1100 may include a digital transmitter 1102, a radio frequency circuit 1104, a device 1114, a digital receiver 1106, and a processing device 1108. The digital transmitter 1102 and the processing device may be configured to receive a baseband signal via connection 1110. A transceiver 1116 may comprise the digital transmitter 1102 and the radio frequency circuit 1104.

In some examples, the communication system 1100 may include a system of devices that may be configured to communicate with one another via a wired or wireline connection. For example, a wired connection in the communication system 1100 may include one or more Ethernet cables, one or more fiber-optic cables, and/or other similar wired communication mediums. Alternatively, or additionally, the communication system 1100 may include a system of devices that may be configured to communicate via one or more wireless connections. For example, the communication system 1100 may include one or more devices configured to transmit and/or receive radio waves, microwaves, ultrasonic waves, optical waves, electromagnetic induction, and/or similar wireless communications. Alternatively, or additionally, the communication system 1100 may include combinations of wireless and/or wired connections. In these and other examples, the communication system 1100 may include one or more devices that may be configured to obtain a baseband signal, perform one or more operations to the baseband signal to generate a modified baseband signal, and transmit the modified baseband signal, such as to one or more loads.

In some examples, the communication system 1100 may include one or more communication channels that may communicatively couple systems and/or devices included in the communication system 1100. For example, the transceiver 1116 may be communicatively coupled to the device 1114.

In some examples, the transceiver 1116 may be configured to obtain a baseband signal. For example, as described herein, the transceiver 1116 may be configured to generate a baseband signal and/or receive a baseband signal from another device. In some examples, the transceiver 1116 may be configured to transmit the baseband signal. For example, upon obtaining the baseband signal, the transceiver 1116 may be configured to transmit the baseband signal to a separate device, such as the device 1114. Alternatively, or additionally, the transceiver 1116 may be configured to modify, condition, and/or transform the baseband signal in advance of transmitting the baseband signal. For example, the transceiver 1116 may include a quadrature up-converter and/or a digital to analog converter (DAC) that may be configured to modify the baseband signal. Alternatively, or additionally, the transceiver 1116 may include a direct RF sampling converter that may be configured to modify the baseband signal.

In some examples, the digital transmitter 1102 may be configured to obtain a baseband signal via connection 1110. In some examples, the digital transmitter 1102 may be configured to up-convert the baseband signal. For example, the digital transmitter 1102 may include a quadrature up-converter to apply to the baseband signal. In some examples, the digital transmitter 1102 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 1102.

In some examples, the transceiver 1116 may include one or more subcomponents that may be used in preparing the baseband signal and/or transmitting the baseband signal. For example, the transceiver 1116 may include an RF front end (e.g., in a wireless environment) which may include a power amplifier (PA), a digital transmitter (e.g., 1102), a digital front end, an institute of electrical and electronics engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 1104) of the transceiver 1116 may be synchronized with the resource controller via the S-plane device, which may contribute to high-accuracy timing with respect to a reference clock.

In some examples, the transceiver 1116 may be configured to obtain the baseband signal for transmission. For example, the transceiver 1116 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 1116 may be configured to generate a baseband signal for transmission. In these and other examples, the transceiver 1116 may be configured to transmit the baseband signal to another device, such as the device 1114.

In some examples, the device 1114 may be configured to receive a transmission from the transceiver 1116. For example, the transceiver 1116 may be configured to transmit a baseband signal to the device 1114.

In some examples, the radio frequency circuit 1104 may be configured to transmit the digital signal received from the digital transmitter 1102. In some examples, the radio frequency circuit 1104 may be configured to transmit the digital signal to the device 1114 and/or the digital receiver 1106. In some examples, the digital receiver 1106 may be configured to receive a digital signal from the RF circuit and/or send a digital signal to the processing device 1108.

In some examples, the processing device 1108 may be a standalone device or system, as illustrated. Alternatively, or additionally, the processing device 1108 may be a component of another device and/or system. For example, in some examples, the processing device 1108 may be included in the transceiver 1116. In instances in which the processing device 1108 is a standalone device or system, the processing device 1108 may be configured to communicate with additional devices and/or systems remote from the processing device 1108, such as the transceiver 1116 and/or the device 1114. For example, the processing device 1108 may be configured to send and/or receive transmissions from the transceiver 1116 and/or the device 1114. In some examples, the processing device 1108 may be combined with other elements of the communication system 1100.

FIG. 12 illustrates a diagrammatic representation of a machine in the example form of a computing device 1200 within which a set of instructions, for causing the machine to perform any one or more of the methods discussed herein, may be executed. The computing system may be configured to implement or direct one or more operations associated with AP interference reduction. The computing device 1200 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1200 includes a processing device (e.g., a processor) 1202, a main memory 1204 (e.g., read-only memory (ROM), flash memory, dynamic random access memory (DRAM) such as synchronous DRAM (SDRAM)), a static memory 1206 (e.g., flash memory, static random access memory (SRAM)) and a data storage device 1216, which communicate via a bus 1208.

Processing device 1202 represents one or more general-purpose processing devices such as a microprocessor, central processing unit, or the like. More particularly, the processing device 1202 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1202 may also include one or more special-purpose processing devices such as an application specific integrated circuit (ASIC), a field programmable gate array (FPGA), a digital signal processor (DSP), network processor, or the like. The processing device 1202 is configured to execute instructions 1226 for performing the operations and steps discussed herein.

The computing device 1200 may further include a network interface device 1222 which may communicate with a network 1218. The computing device 1200 also may include a display device 1210 (e.g., a liquid crystal display (LCD) or a cathode ray tube (CRT)), an alphanumeric input device 1212 (e.g., a keyboard), a cursor control device 1214 (e.g., a mouse) and a signal generation device 1220 (e.g., a speaker). In at least one example, the display device 1210, the alphanumeric input device 1212, and the cursor control device 1214 may be combined into a single component or device (e.g., an LCD touch screen).

The data storage device 1216 may include a computer-readable storage medium 1224 on which is stored one or more sets of instructions 1226 embodying any one or more of the methods or functions described herein. The instructions 1226 may also reside, completely or at least partially, within the main memory 1204 and/or within the processing device 1202 during execution thereof by the computing device 1200, the main memory 1204 and the processing device 1202 also constituting computer-readable media. The instructions may further be transmitted or received over a network 1218 via the network interface device 1222.

While the computer-readable storage medium 1224 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

### EXAMPLES

The following provide examples according to the present disclosure.

### Example 1: Backhaul Detection Using Autocorrelation

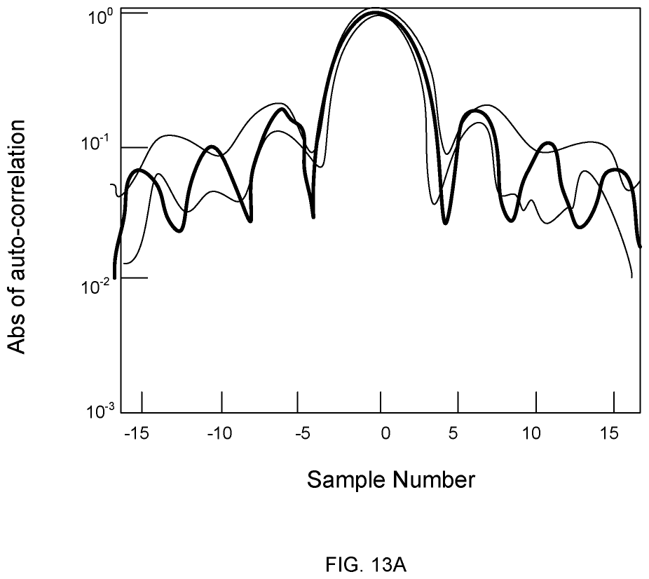

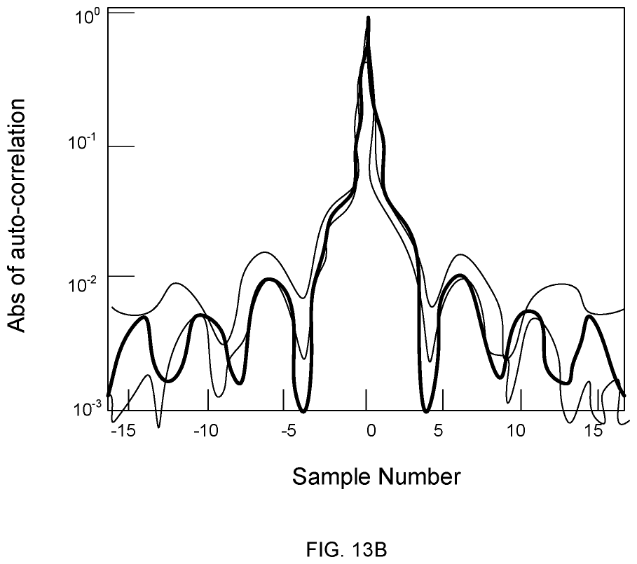

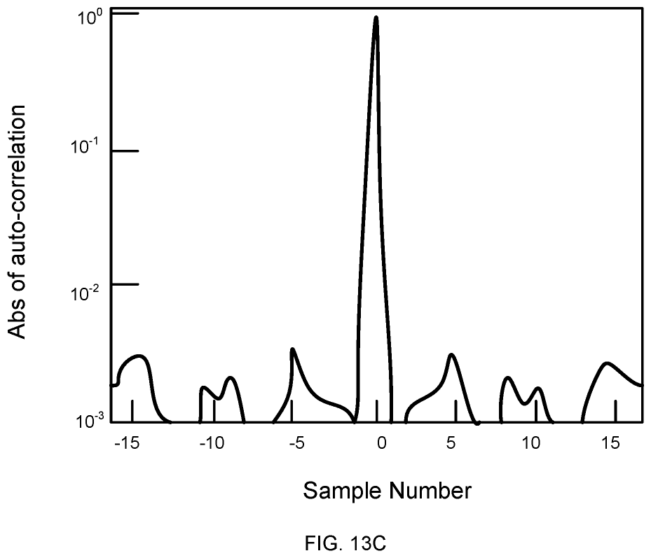

As illustrated in FIGS. 13A to 13C, backhaul detection at a Wi-Fi® AP was computed using a number of operations. The signal at the Wi-Fi® AP was processed to determine the presence of a carrier signal. The presence of the carrier signal was determined by computing the auto-correlation of the signal to determine the shape of the signal. A root-raised-cosine pulse (which may be detected using a root-raised cosine (RRC) filter), may indicate that a carrier signal is present. When the carrier signal is unknown, then backhaul detection at the Wi-Fi® AP may be performed by determining the presence of the carrier signal in a plurality of frequencies that the channel is using.

In FIGS. 13A to 13C, the symbol rate was 200 megabits per second, the sampling rate was 800 MHz. Therefore, the period was about 4 samples. The auto-correlation of the signal for the frequency offset was determined from 0 kHz to 1 MHz.

As illustrated in FIG. 13A, the autocorrelation of the backhaul signal as received at the Wi-Fi® AP had a root-raised cosine shape because the absolute value of the autocorrelation of the signal dipped at periodic intervals based on the sample number. In this example, the signal to noise ratio was 20 dB.

As illustrated in FIG. 13B, the autocorrelation of the backhaul signals as received at the Wi-Fi® AP had a root-raised-cosine shape because the absolute value of the autocorrelation of the signal dipped at periodic intervals based on the sample number. In this example, the signal to nose ratio was 0 dB. Therefore, using the autocorrelation to determine the presence of the carrier signal may provide results for one or more of a positive SNR (e.g., 20 dB) and for an SNR of 0 dB.

As illustrated in FIG. 13C, the autocorrelation of the backhaul signals as received at the Wi-Fi® AP did not have a root-raised-cosine shape because the absolute value of the autocorrelation of the signal did not dip at periodic intervals based on the sample number. In this example, no signal was present.

Backhaul detection at the Wi-Fi® AP may be validated based on the presence of a preamble. The preamble and other fields present in the signal may be determined by using the auto-correlation to compute the carrier frequency and using the shape of the auto-correlation to compute the symbol rate. Backhaul detection at the Wi-Fi® AP may be validated in addition or in the alternative by computing the preamble repetition.

As shown in 13A-13C, the symbol rate (if present) may be computed by dividing the sampling rate by the number of samples in a period. The number of samples in FIGS. 13A to 13C was 4 in a period and the sampling rate was 800 MHz to provide a symbol rate of 200 Megabauds. Furthermore the preamble, which may be a selected number of symbols in a low order modulation), may be determined using the autocorrelation to determine the presence of the preamble or the repetition of the preamble.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the disclosure and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. An access point (AP), comprising:
a processing device configured to:
detect, at the AP, a backhaul transmission received from a backhaul modem;
identify, at the AP, one or more backhaul frequency channels present in the backhaul transmission;
compute, at the AP, one or more complementary backhaul frequency channels based on the one or more backhaul frequency channels; and
compute, at the AP, one or more operating frequency channels, wherein the one or more operating frequency channels do not include: the one or more backhaul frequency channels and the one or more complementary backhaul frequency channels; and
a transceiver configured to:
transmit, from the AP to a wireless device, a signal using the one or more operating frequency channels.

2. The access point of claim 1, wherein the processing device is further configured to:
compute, at the AP, an autocorrelation of the backhaul transmission to determine when a carrier signal is present.

3. The access point of claim 1, wherein the processing device is further configured to:
determine, at the AP, a preamble based on one or more of a carrier frequency or a symbol rate, wherein the one or more of the carrier frequency or the symbol rate is determined from an autocorrelation of a carrier signal; or
determine, at the AP, a preamble repetition.

4. The access point of claim 1 wherein the processing device is further configured to:
acquire, at the AP from an AFC server, one or more signal parameters for the one or more backhaul frequency channels;
determine, at the AP, backhaul interference in the one or more backhaul frequency channels based on the signal parameters; and
adjust, at the AP, the one or more operating channels based on the backhaul interference in the one or more backhaul frequency channels.

5. The access point of claim 1, wherein the processing device is further configured to:
compute, at the AP, backhaul interference in the one or more backhaul frequency channels by correlating one or more of a backhaul preamble or a backhaul pilot sequence.

6. The access point of claim 1, wherein the processing device is further configured to:
compute, at the AP, one or more of an AP location or a backhaul location based on one or more signal parameters for the one or more backhaul frequency channels.

7. An access point (AP), comprising:
a transceiver configured to:
receive, at the AP from a backhaul modem, a downlink signal including a backhaul frame and a signaling aid; and
a processing device configured to:
identify, at the AP, a signaling aid in the downlink signal to detect a downlink backhaul frequency channel; and
determine, based on the signaling aid, one or more operating frequencies for the AP, wherein the operating frequencies do not include the downlink backhaul frequency channel.

8. The access point of claim 7, wherein the transceiver is configured to transmit using one or more of:
a low power indoor transmit power mode when the one or more operating frequencies do not include one or more uplink backhaul frequency channels.

9. The access point of claim 7, further comprising a receiver configured to search for the downlink signal using dynamic frequency selection.

10. The access point of claim 7, wherein the signaling aid is not aligned to an AP raster.

11. The access point of claim 7, wherein the transceiver is configured to:
receive additional operating frequencies from an automatic frequency coordination (AFC) server;
receive one or more of an AP location or a backhaul location from the AFC server; and
transmit using standard power based on the additional operating frequencies and the one or more of the AP location or the backhaul location.

12. The access point of claim 7, wherein the signaling aid is an AP transmission preamble and wherein the processing device is further configured to:
determine, at the AP, a clear channel assessment (CCA) busy indication based on the AP transmission preamble; and
determine, based on the CCA busy indication, the one or more operating frequency channels for the AP.

13. The access point of claim 12, wherein the AP transmission preamble comprises one or more of: a legacy short training field (L-STF), legacy long training field (L-LTF), or legacy signal field (L-SIG).

14. A backhaul modem, comprising:
a processing device configured to:
compute, at the backhaul modem, a signaling aid configured for detection by an access point (AP);
encode, at the backhaul modem, the signaling aid in combination with a backhaul frame; and
send, from the backhaul modem for transmission to the AP, a downlink signal including the backhaul frame and the signaling aid to a transceiver; and
the transceiver configured to transmit the downlink signal including the backhaul frame and the signaling aid to the AP.

15. The backhaul modem of claim 14, wherein the signaling aid is an AP transmission preamble.

16. The backhaul modem of claim 15, wherein the AP transmission preamble comprises one or more of: a legacy short training field (L-STF), legacy long training field (L-LTF), or legacy signal field (L-SIG).

17. The backhaul modem of claim 14, wherein the processing device is configured to:
encode, at the backhaul modem, the signaling aid in combination with the backhaul frame periodically.

18. The backhaul modem of claim 14, wherein:
a signaling aid power spectral density matches a backhaul power spectral density; or
the signaling aid is configured to have a bandwidth of one or more of: 3.5 MHz, 7 MHz, 14 MHz, 28 MHz, or 56 MHz.

19. The backhaul modem of claim 14, wherein the processing device is configured to:
identify, at the backhaul modem, the signaling aid in a downlink signal;
skip, at the backhaul modem, decoding of the signaling aid; and
continue, at the backhaul modem, decoding of the downlink signal.

20. The backhaul modem of claim 14, wherein the transceiver is further configured to:
transmit the downlink signal using a first backhaul transmit path; and
transmit a second downlink signal comprising a second signaling aid in combination with a second backhaul frame using a second backhaul transmit path.
